(19) United States
(12) Patent Application Publication
(10) Pub. No.: US 2026/0104018 A1
(43) Pub. Date: Apr. 16, 2026

(54) ENGINE INJECTOR CONTROL DEVICE AND METHOD

(71) Applicants: HYUNDAI MOTOR COMPANY, Seoul (KR); KIA CORPORATION, Seoul (KR); HYUNDAI KEFICO CORPORATION, Gunpo-si (KR)

(72) Inventors: Myung Yoon Kim, Hwaseong-si (KR); Jin Noh Lee, Seoul (KR)

(73) Assignees: HYUNDAI MOTOR COMPANY, Seoul (KR); KIA CORPORATION, Seoul (KR); HYUNDAI KEFICO CORPORATION, Gunpo-si (KR)

(21) Appl. No.: 19/353,349

(22) Filed: Oct. 8, 2025

(30) Foreign Application Priority Data
Oct. 10, 2024 (KR) 10-2024-0137743
Feb. 26, 2025 (KR) 10-2025-0025298

(51) Int. Cl. F02D 41/40

(52) U.S. Cl. CPC F02D 41/403; F02D 2200/0602; F02D 2200/0606; F02D 2200/0618; F02D 2200/101; F02D 2200/602

(57) ABSTRACT

An engine injector control device and method include an opening delay calculation unit configured to receive a predetermined operating condition and an injection strategy. The opening delay calculation unit is further configured to determine an opening delay difference between an opening delay of a first injection and an opening delay of a subsequent injection of a plurality of subsequent injections following the first injection during a multi-stage injection by an injector. The engine injector control device and method also include an injector driving unit configured to operate the injector based on the opening delay difference determined in the opening delay calculation unit.

### CROSS-REFERENCE TO RELATED APPLICATION

This application claims, under 35 U.S. C. § 119(a), the benefit of and priority to Korean Patent Application No. 10-2024-0137743, filed Oct. 10, 2024, and Korean Patent Application No. 10-2025-0025298, filed Feb. 26, 2025, the entire contents of which are incorporated herein by reference.

### BACKGROUND

### Technical Field

The present disclosure relates to a technology for controlling an injector injecting fuel into an engine.

### Description of the Related Art

An injector of an engine is a device for injecting fuel to an intake port or a combustion chamber, where the desired amount of fuel must be accurately injected at a precise time.

In a Gasoline Direct Injection (GDI) engine, when multi-stage injection is performed with an injector, a fuel injection distance becomes shorter, thereby solving exhaust emission problems and engine oil increase problems caused by fuel reaching a combustion chamber wall.

In other words, when a combustion chamber temperature is low, fuel vaporization is insufficient, so fuel injected from an injector reaches a combustion chamber wall and forms a locally rich mixture, thereby increasing the exhaust emission of an engine. Furthermore, fuel that reaches the combustion chamber wall causes a wall wetting phenomenon, and the fuel passes through a piston ring and is mixed with an engine oil, which may result in engine oil dilution and/or increase. However, multi-stage injection may solve these problems.

An engine that converts a reciprocating motion of a piston into a rotational motion operates constantly in a periodically repeating cycle to generate power. Each cycle involves injecting fuel necessary for power generation, where “multi-stage injection” refers to a method of injecting the required fuel (i.e., the fuel required during one cycle) in multiple stages, rather than all at once.

As such, multi-stage injection by the injector occurs by repeated opening and closing of the injector during a short period of time. A subsequent injection after the first injection is influenced by the preceding injection, and the actual injection amount tends to differ from the original target control injection amount.

Conventionally, a fuel amount correction map based on required engine torque and speed is used for each multi-stage injection count, so that the actual injection amount of the injector follows (i.e., matches) the target control injection amount.

The above information disclosed in this Background section is only for enhancement of understanding of the background of the disclosure. Therefore, the Background section may contain information that does not form the prior art that is already known to a person of ordinary skill in the art.

### SUMMARY

Accordingly, the present disclosure has been made in an effort to solve the above-described problems associated with the prior art. The present disclosure provides an engine injector control device and method. The device and method are configured to simplify and improve the accuracy of a correction of a subsequent injection following a previous injection during a multi-stage injection by an injector, enabling more accurate fuel injection control. The device and method further reduce a dwell time between injection times, thereby reducing exhaust emissions and oil consumption.

Technical problems to be solved by the present disclosure are not limited to the above-mentioned problems, and other technical problems, which are not mentioned above, should be clearly understood from the following descriptions by those having ordinary skill in the art to which the present disclosure pertains.

In order to achieve the objectives described above, the present disclosure provides an engine injector control device. The engine injector control device includes an opening delay calculation unit configured to receive a predetermined operating condition and an injection strategy. The opening delay calculation unit is further configured to determine an opening delay difference between an opening delay of a first injection and an opening delay of a subsequent injection of a plurality of subsequent injections following the first injection during a multi-stage injection by an injector. The engine injector control device also includes an injector driving unit configured to operate the injector based on the opening delay difference determined in the opening delay calculation unit.

The operating condition may include at least one selected from an accelerator pedal operation amount, an engine speed, a fuel rail pressure, and a fuel temperature. The injection strategy may be configured to be provided to the opening delay calculation unit from an injection strategy determination unit. The injection strategy determination unit may be configured to receive the operating condition and to determine a multi-stage injection count, an injection amount distribution, an initial injection timing, and a dwell time.

An injection time calculation unit configured to receive the injection strategy and to calculate an injection time may be provided between the injection strategy determination unit and the opening delay calculation unit, and the opening delay calculation unit may be configured to receive the injection time from the injection time calculation unit.

The injector driving unit may be configured to drive (i.e., operate) the injector for a duration equal to the injection time provided by the injection time calculation unit minus the opening delay difference provided by the opening delay calculation unit.

The injector driving unit may be configured to operate the injector by shortening a rear (i.e., end) stage of the injection time by the opening delay difference.

The opening delay calculation unit may be provided with a map of the opening delay difference according to the fuel rail pressure, the fuel temperature, the dwell time, and the injection time.

The injector driving unit may be configured to operate the injector by subtracting the opening delay difference from each respective injection time of the plurality of subsequent injections following the first injection during the multi-stage injection.

The engine injector control device may further include a closing delay calculation unit configured to receive the injection time from the injection time calculation unit and calculate or determine a closing delay. The closing delay calculation unit may be further configured to provide the closing delay to the injector driving unit and correct control errors due to each respective closing delay of the first injection and the plurality of subsequent injections following the first injection during the multi-stage injection.

In addition, in order to achieve the objectives described above, the present disclosure provides an engine injector control device. The engine injector control device includes an opening delay calculation unit configured to receive a fuel rail pressure, a fuel temperature, a dwell time, and an injection time. The engine injector control device is further configured to output an opening delay difference between an opening delay of a first injection and an opening delay of a subsequent injection of a plurality of subsequent injections following the first injection during a multi-stage injection by an injector. The engine injector control device also includes an injector driving unit configured to drive the injector based on the opening delay difference provided from the opening delay calculation unit.

The injector driving unit may be configured to operate the injector for a duration equal to each respective injection time of the plurality of subsequent injections following the first injection during the multi-stage injection minus the opening delay difference.

The injector driving unit may be configured to operate the injector by shortening an end stage of each respective injection time by the opening delay difference.

The opening delay calculation unit may be provided with a map of the opening delay difference according to the fuel rail pressure, the fuel temperature, the dwell time, and the injection time.

The engine injector control device may further comprise a closing delay calculation unit configured to receive the injection time from the injection time calculation unit and calculate or determine a closing delay. The closing delay calculation unit may be further configured to provide the closing delay to the injector driving unit and correct control errors due to each respective closing delay of the first injection and the plurality of subsequent injections following the first injection during the multi-stage injection.

In addition, in order to achieve the objectives described above, the present disclosure provides an engine injector control method. The engine injector control method includes determining an injection strategy of an injector by receiving a predetermined operating condition and calculating or determining an injection time of the injector according to the injection strategy. The engine injector control method further includes determining an opening delay difference between an opening delay of a first injection and an opening delay of a subsequent injection of a plurality of subsequent injections following the first injection according to the operating condition, the injection strategy, and the injection time during a multi-stage injection by the injector. The engine injector control method also includes driving or operating the injector by using the opening delay difference.

The operating condition may include at least one selected from an accelerator pedal operation amount, an engine speed, a fuel rail pressure, and a fuel temperature. The injection strategy may include a multi-stage injection count of the injector, an injection amount distribution, an initial injection timing, and a dwell time that are determined by receiving the operating condition.

The opening delay difference may be calculated from a map of the opening delay difference according to the fuel rail pressure, the fuel temperature, the dwell time, and the injection time.

In the operating of the injector, the injector may be operated based on the opening delay difference for each respective injection time of the plurality of subsequent injections following the first injection during the multi-stage injection by the injector.

In the operating of the injector, the injector may be operated for a duration equal to each respective injection time of the plurality of subsequent injections following the first injection during the multi-stage injection by the injector minus the opening delay difference.

For the plurality of subsequent injections following the first injection, the injector may be operated by shortening an end stage of each respective injection time by the opening delay difference.

The engine injector control method may further include calculating or determining a closing delay based on the injection time and correcting control errors due to each respective closing delay of the first injection and the plurality of subsequent injections following the first injection during the multi-stage injection by the injector.

Accordingly, in the present disclosure, correction of a subsequent injection of a plurality of subsequent injections following a first injection may be more simply and accurately performed during the multi-stage injection by the injector, enabling more accurate fuel injection control. A dwell time between injection times may be reduced, thereby reducing exhaust emissions and oil consumption.

The above and other features of the disclosure are discussed below. The effects obtained by the present disclosure are not limited to the aforementioned effects, and other effects, which are not mentioned above, should be clearly understood by those having ordinary skill in the art from the following description.

### BRIEF DESCRIPTION OF THE DRAWINGS

The above and other aspects, features, and other advantages of the present disclosure should be more clearly understood from the following description taken in conjunction with the accompanying drawings, in which:

FIG. 1 is a configuration diagram illustrating an embodiment of an engine injector control device according to an embodiment of the present disclosure;

FIG. 2 is a view illustrating an example of a multi-stage injection by an injector according to a time axis, the multi-stage injection having a total of eight injections, according to an embodiment of the present disclosure;

FIG. 3 is a view illustrating an opening delay and a closing delay of an injector injection, according to an embodiment of the present disclosure;

FIG. 4 is a graph comparing a first injection and a second injection that are overlapped and performed by sequentially applying the same injection current to the same injector, according to an embodiment of the present disclosure;

FIG. 5 is a graph in which a dwell time is applied longer compared to that of FIG. 4, according to an embodiment of the present disclosure;

FIG. 6 is a graph in which each opening delay is tested while the dwell time is changed for six different injectors, according to an embodiment of the present disclosure;

FIG. 7 is a graph in which an injector energizing time is applied longer compared to that of FIG. 6, according to an embodiment of the present disclosure;

FIG. 8 is a view illustrating a principle of the present disclosure in comparison with a conventional control method, according to an embodiment of the present disclosure; and

FIG. 9 is a flowchart illustrating an engine injector control method according to an embodiment of the present disclosure.

It should be understood that the appended drawings are not drawn to scale, presenting a somewhat simplified representation of various features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawings.

### DETAILED DESCRIPTION

Hereinafter, various embodiments of the present disclosure are described in detail with reference to the accompanying drawings. Detailed description of known technologies have been omitted when it was determined that the detailed description of the known technologies obscures the embodiments of the present disclosure. In addition, the accompanying drawings are merely for easy understanding of the embodiments of the present disclosure, but the technical ideas disclosed in the present disclosure are not limited by the accompanying drawings, and should be understood to include all modifications, equivalents and substitutes included within the spirit and technical scope of the present disclosure.

Terms including ordinals such as “first” or “second” used herein may be used to describe various components, but the components are not limited by the terms. The terms are used only for the purpose of distinguishing one constituent element from another constituent element.

As used herein, the singular forms are intended to include the plural forms as well, unless the context clearly indicates otherwise.

In the present specification, it is to be understood that terms such as “including”, “having”, and so on are intended to indicate the existence of the features, numbers, steps, actions, elements, components, or combinations thereof disclosed in the specification, and are not intended to preclude the possibility that one or more other features, numbers, steps, actions, elements, components, or combinations thereof may exist or may be added.

In the following description, the expressions “module” and “part” contained in terms of constituent components to be described are selected or used together in consideration only of the convenience of writing the following specification, and the expressions “module” and “part”do not necessarily have different meanings or roles.

When a component is described as being “connected”, “coupled”, or “linked” to another component, that component may be directly connected, coupled, or linked to that other component. However, it should be understood that yet another component between each of the components may be present. In contrast, it should be understood that when a component is referred to as being “directly coupled” or “directly connected” to another component, there are no intervening components present.

The term “unit,” “control unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof. In addition, “unit” or “control unit” included in the names of an internal configuration of the present disclosure generally refer to a controller that controls a specific function and do not mean a generic function unit.

In addition, “controller” may include a communication device configured to communicate with another controller or a sensor to control a function assigned thereto, a memory configured to store an operating system, logic commands, executable instructions, and input and output information, and at least one processor configured to execute the commands and instructions to perform determinations, calculations, and decisions necessary to control the assigned function(s).

When a component, unit, controller, device, element, apparatus, or the like of the present disclosure is described as having a purpose or performing an operation, function, or the like, the component, unit, controller, device, element, apparatus, or the like should be considered herein as being “configured to” meet that purpose or to perform that operation or function. Each component, unit, controller, device, element, apparatus, and the like may separately embody or be included with a processor and a memory, such as a non-transitory computer readable media, as part of the apparatus.

Any number or variety of components in any of the configurations described herein can be included in the present disclosure, as described herein. The components can include any combination of the features described herein, and can be arranged in any of the various configurations described herein. The structure and arrangement of components of the present disclosure, as well as the concepts regarding their use can apply not only to the specific examples discussed herein, but to any number of embodiments in any combination. Various examples of the present disclosure including some having various features in various arrangements are described below with reference to the drawings.

Hereinafter, embodiments disclosed in the present disclosure are described in detail with reference to the accompanying drawings. In the present disclosure, the same or similar components are denoted by the same or similar reference numerals, and a repeated description thereof is omitted.

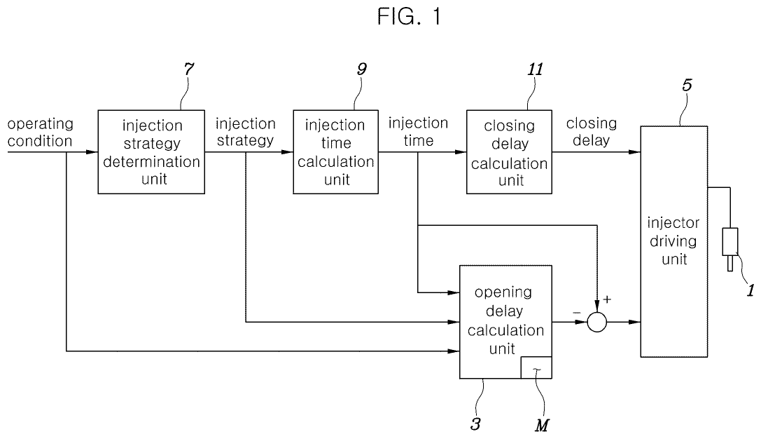

Referring to FIG. 1, an engine injector control device according to an embodiment of the present disclosure includes an opening delay calculation unit 3 configured to receive a predetermined operating condition and an injection strategy. The opening delay calculation unit 3 is further configured to determine an opening delay difference ΔOD between an opening delay OD of a first injection and an opening delay OD of a subsequent injection following the first injection during a multi-stage injection by an injector 1. The engine injector control device also includes an injector driving unit 5 configured to operate (i.e., drive) the injector 1 considering the opening delay difference ΔOD determined in the opening delay calculation unit 3.

The operating condition includes at least one selected from an accelerator pedal operation amount, an engine speed, a fuel rail pressure, and a fuel temperature. The injection strategy is configured to be provided to the opening delay calculation unit 3 from an injection strategy determination unit 7. The injection strategy determination unit 7 is configured to receive the operating condition and to determine a multi-stage injection count, an injection amount distribution, an initial injection timing, and a dwell time.

In addition, an injection time calculation unit 9 configured to receive the injection strategy and to calculate or determine an injection time is provided between the injection strategy determination unit 7 and the opening delay calculation unit 3. The opening delay calculation unit 3 is configured to receive the injection time from the injection time calculation unit 9.

In other words, when the injection strategy determination unit 7 receives the operating condition and determines the injection strategy (including the multi-stage injection count, the injection amount distribution, the initial injection timing, and the dwell time), the injection time calculation unit 9 receives the injection strategy and calculates or determines the injection time of the injector 1. Additionally, the opening delay calculation unit 3 receives the injection time, the injection strategy, and the operating condition and calculates or determines the opening delay difference ΔOD. Accordingly, when the injector 1 is operated (i.e., driven), the injection of fuel may be performed based on the opening delay difference ΔOD.

The injection strategy determination unit 7 determines, through information (i.e., the accelerator pedal operation amount and the engine speed), a total fuel amount that the injector 1 is required to inject per engine cycle, and the multi-stage injection count, indicating how many times the total fuel amount is required to be divided for injection. The injection strategy determination unit 7 further determines the injection amount distribution, allocating the required fuel for each injection in the multi-stage injection, and the initial injection timing, which marks a start point of the first injection among the injections in the multi-stage injection. The injection strategy determination unit 7 also determines the dwell time, during which injection is temporarily stopped between each injection (i.e., each stage).

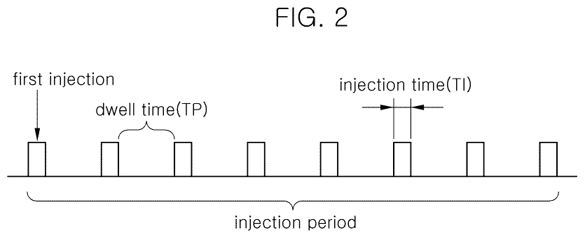

For example, referring to FIG. 2, eight multi-stage injections are expressed on a time axis. Injections are performed sequentially from the first injection (i.e., on the left) to the eighth injection (i.e., on the right), according to the flow of time, resulting in eight total injections. Furthermore, the total time for performing eight injections is referred to as an “injection period”, a time for performing each injection is referred to as an “injection time TI”, and a time between each injection time is referred to as a “dwell time TP”.

In addition, a “subsequent injection” refers to any injection among a second injection to an eighth injection, following the first injection in the example of the eight multi-stage injections described above, or is used as a collective term for these injections.

The injection time calculation unit 9 receives the injection strategy from the injection strategy determination unit 7 and calculates or determines the injection time TI that can satisfy the injection strategy.

In other words, the injection time calculation unit 9 considers the multi-stage injection count, the injection amount distribution, and a standard injection amount according to an injector energizing time of the corresponding injector 1. The injection time calculation unit 9 then calculates or determines the injection time TI that can satisfy the injection amount distribution in each injection.

For reference, the injection time TI refers to a duration (i.e., a time) for applying an injection current to the injector 1. The injection time TI is distinguished from a duration in which fuel is actually injected (i.e., during which fuel injection occurs in the actual injector 1).

The opening delay calculation unit 3 receives the fuel rail pressure and the fuel temperature from the operating condition, the dwell time TP from the injection strategy, and the injection time TI calculated by the injection time calculation unit 9. The opening delay calculation unit 3 further calculates or determines the opening delay difference ΔOD.

The opening delay difference ΔOD refers to a difference between an opening delay OD of the first injection and an opening delay OD of the subsequent injection (i.e., of a plurality of subsequent injections) following the first injection during the multi-stage injection by the injector 1.

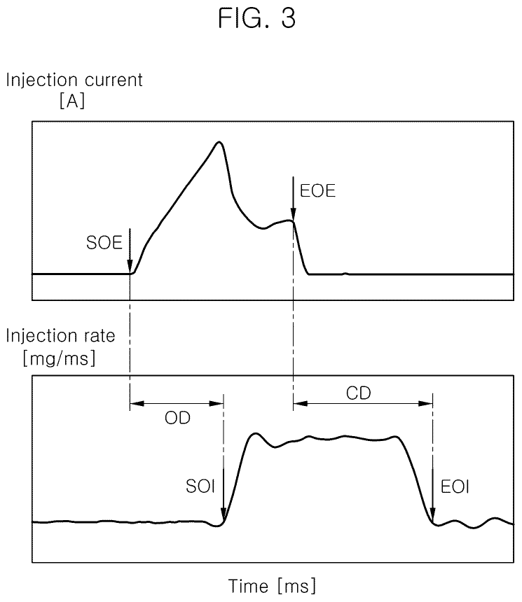

As illustrated in FIG. 3, the “opening delay OD” of injection refers to a time from an injector energizing start point SOE according to an injection command of the injector 1 to a time point when a nozzle of the injector 1 is actually opened and fuel injection is started SOI.

In FIG. 3, a “closing delay CD”, which is a time from the point when injector energizing ends EOE to the point when the injector injection actually ends EOI, is also illustrated.

The opening delay OD and the closing delay CD as described above ultimately become major causes of differences between the target control injection amount of the injector control device and the actual injection amount of the injector 1.

Particularly, the opening delay OD tends to show significant differences between what occurs in the first injection during the multi-stage injection and what occurs in the subsequent injection (i.e., of a plurality of subsequent injections) following the first injection.

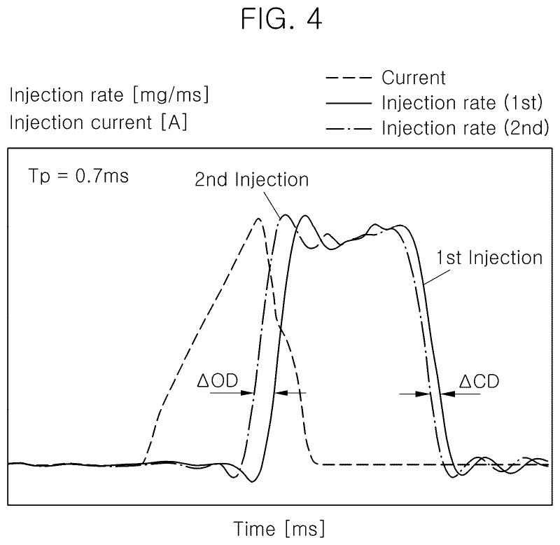

FIG. 4 is a graph comparing the first injection and the second injection that are overlapped and performed by sequentially applying the same injection current to the same injector 1. Furthermore, in FIG. 4, the opening delay OD of the second injection, which is the time from the injector energizing point to the second injection start point, is shorter compared to the opening delay OD of the first injection, which is the time from the injector energizing point to the first injection start point.

In other words, even for the same injection current, the opening delay difference ΔOD occurs between the opening delay OD of the first injection and the opening delay OD of the second injection, and this difference is considerably larger than the closing delay difference ΔCD. As illustrated in FIG. 4, this difference is a very significant difference.

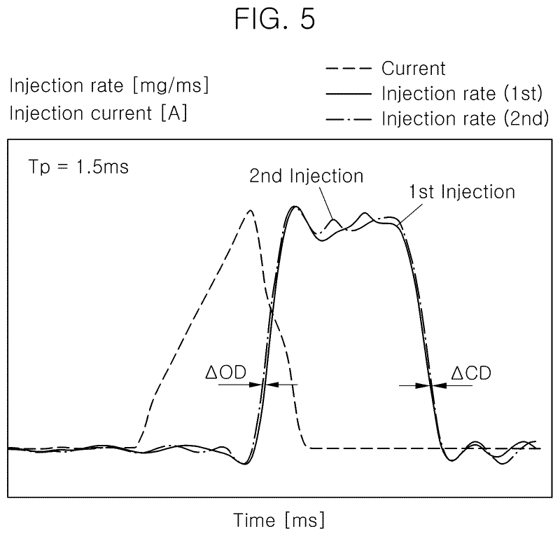

FIG. 4 shows test results with the dwell time TP between injections set to 0.7 ms, while FIG. 5 shows test results under the same conditions with the dwell time TP changed to 1.5 ms. In FIG. 5, the opening delay difference ΔOD and the closing delay difference ΔCD are significantly reduced and occur minimally.

From the results of these two tests, it can be seen that the opening delay difference ΔOD and the closing delay difference ΔCD increase as the dwell time TP becomes shorter, and the opening delay difference ΔOD is relatively more affected.

In addition, referring to FIG. 4 and FIG. 5, the maximum injection rate and rising and falling slopes of the injection rate shown in the injection rate graph of the first injection are almost the same as the maximum injection rate and rising and falling slopes of the injection rate of the second injection, respectively. This indicates that, when only correcting the opening and closing points of the injector 1, all injections in the multi-stage injection may be controlled to exhibit the same injection rate characteristics.

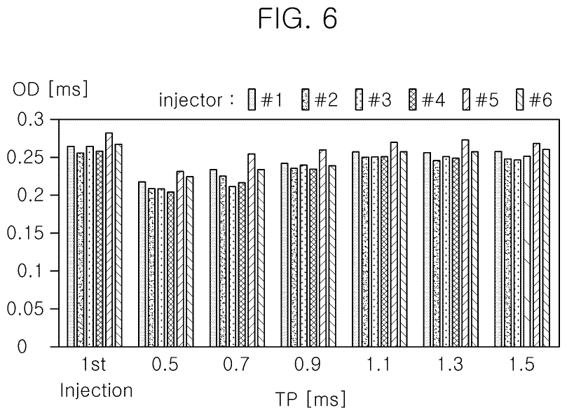

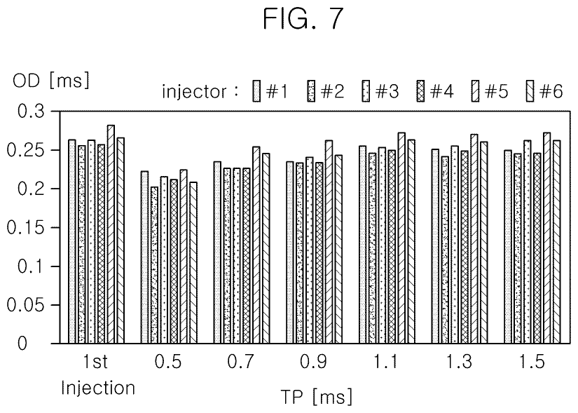

FIG. 6 is a graph in which the opening delay OD of six different injectors 1 is tested while the dwell time TP is changed, with the injector energizing time of the injector 1 set to 0.35 ms. Furthermore, FIG. 7 is a graph in which the same test is performed under the same conditions and methods as FIG. 6, except that the injector energizing time of the injector 1 was changed to 1.0 ms.

Referring to FIG. 6 and FIG. 7, in all cases for all injectors 1, the first injection has the largest opening delay OD, and the opening delay OD of the subsequent injection (i.e., of a plurality of subsequent injections) tends to become shorter as the dwell time TP of the multi-stage injection becomes shorter due to the influence of the previous injection. Furthermore, the opening delay characteristics that each injector 1 has are maintained even when the dwell time TP is changed.

FIG. 6 and FIG. 7 show nearly identical forms, confirming that even when the injector energizing time of the injector 1 (i.e., the injection time TI) is changed, the opening delay OD of the injector 1 does not change significantly.

However, the opening delay OD of the injector 1 relative to the injection time TI is significantly affected by injection time TI when the injection time TI is very short and the injection ends before the injector 1 reaches a stable opening state.

Therefore, in the present disclosure, the opening delay difference ΔOD is calculated based on the fuel rail pressure, the fuel temperature, the dwell time TP, and the injection time TI together.

In an embodiment, the opening delay calculation unit 3 is provided with a map M of the opening delay difference ΔOD according to fuel rail pressure, the fuel temperature, the dwell time TP, and the injection time TI, so that the opening delay difference ΔOD corresponding to the input fuel rail pressure, the input fuel temperature, the input dwell time, and the input injection time may be selected from the map M and immediately output.

The injector driving unit 5 is configured to operate (i.e., drive) the injector 1 for a duration equal to the injection time TI provided by the injection time calculation unit 9 minus the opening delay difference ΔOD provided by the opening delay calculation unit 3.

In other words, the injector driving unit 5 operates (i.e., drives) the injector 1 by subtracting the opening delay difference ΔOD from each injection time TI of all subsequent injections (i.e., a plurality of subsequent injections) following the first injection during the multi-stage injection. This may prevent injection of surplus injection amount that would result from subsequent injections (i.e., a plurality of subsequent injections) starting relatively earlier than the first injection. Additionally, this may reduce the injection time TI of subsequent injections (i.e., a plurality of subsequent injections) so that injection corresponding to the original target control injection amount occurs during the subsequent injections (i.e., plurality of subsequent injections).

In an embodiment, the injector driving unit 5 is configured to operate (i.e., drive) the injector 1 by shortening an end stage of the injection time TI by the opening delay difference ΔOD.

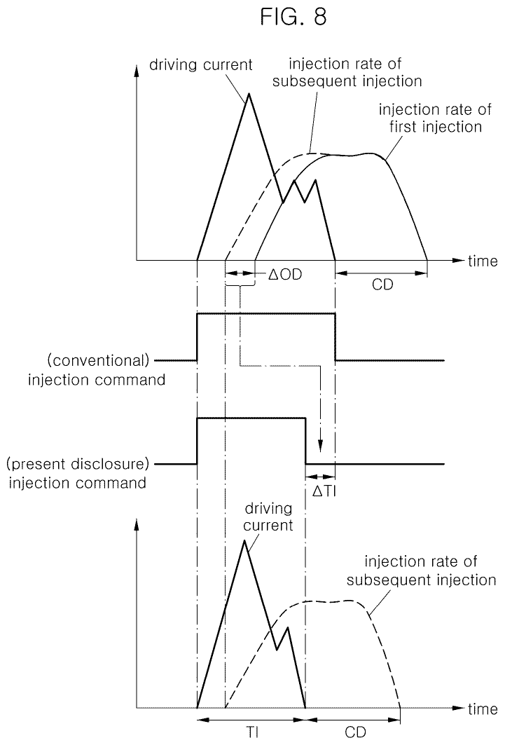

FIG. 8 schematically shows the principle of the present disclosure in comparison with a conventional control method. In FIG. 8, an upper side represents the opening delay difference ΔOD according to the conventional control method, and a lower side represents driving the injector 1 by shortening the end stage of the injection time TI by the opening delay difference ΔOD according to the control method of the present disclosure.

Therefore, according to the present disclosure, the injector 1 performs nearly accurate injection based on the target control injection amount of the injector control device, resulting in a significant increase in the precision and the accuracy of the injector control.

In addition, the injection period for injecting the total fuel amount (i.e., during which the injector 1 injects all the total fuel amount to be injected) in the corresponding cycle may be shortened.

Furthermore, even if the minimum driving time and the minimum dwell time are further shortened compared to that of the conventional method, by calculating the opening delay difference ΔOD based on the driving time and the dwell time TP and reflecting the opening delay difference ΔOD in subsequent injections (i.e., plurality of subsequent injections) following the first injection, the injector 1 may accurately inject the target control injection amount. Therefore, applying the multi-stage injection under broader engine operating conditions may reduce exhaust emissions and oil consumption.

For reference, a closing delay calculation unit 11 is illustrated in FIG. 1. The closing delay calculation unit 11 is configured to receive the injection time TI from the injection time calculation unit 9, to calculate or determine the closing delay CD, and to provide the closing delay CD to the injector driving unit 5. Therefore, the control errors due to the closing delay CD in each injection by the multi-stage injection may be corrected, and a conventional technology may be used for calculating the closing delay CD and using the closing delay CD to correct the control errors.

The present disclosure as described above may be expressed as follows.

In an embodiment, the engine injector control device of the present disclosure includes the opening delay calculation unit 3 configured to receive the fuel rail pressure, the fuel temperature, the dwell time TP, and the injection time TI. The opening delay calculation unit 3 is further configured to output the opening delay difference ΔOD between the opening delay OD of the first injection and the opening delay OD of the subsequent injection (i.e., of a plurality of subsequent injections) following the first injection during the multi-stage injection by the injector 1. The engine injector control device also includes the injector driving unit 5 configured to operate (i.e., drive) the injector 1 based on the opening delay difference ΔOD provided from the opening delay calculation unit 3.

The injector driving unit 5 may be configured to operate (i.e., drive) the injector 1 during the multi-stage injection, for a duration equal to the injection time TI minus the opening delay difference ΔOD for all subsequent injections (i.e., a plurality of subsequent injections) following the first injection during the multi-stage injection.

The injector driving unit 5 may be configured to operate (i.e., drive) the injector 1 by shortening an end stage of each injection time TI by the opening delay difference ΔOD.

The opening delay calculation unit 3 may be provided with the map M of the opening delay difference ΔOD according to the fuel rail pressure, the fuel temperature, the dwell time TP, and the injection time TI.

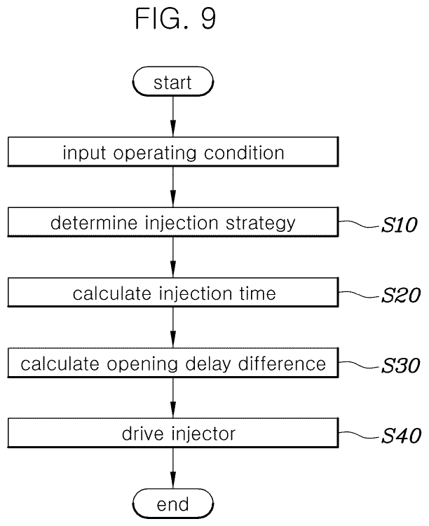

As illustrated in the flowchart shown in FIG. 9, an embodiment of an engine injector control method of the present disclosure includes determining the injection strategy of the injector 1 by receiving the predetermined operating condition in step or operation S10 and calculating or determining the injection time TI of the injector 1 according to the injection strategy in step or operation S20. The method further includes determining the opening delay difference ΔOD between the opening delay OD of the first injection and the opening delay OD of the subsequent injection (i.e., of a plurality of subsequent injections) following the first injection according to the operating condition, the injection strategy, and the injection time TI during the multi-stage injection by the injector in step or operation S30. The method also includes driving the injector 1 by using the opening delay difference ΔOD in step or operation S40.

The operating condition includes at least one selected from the accelerator pedal operation amount, the engine speed, the fuel rail pressure, and the fuel temperature. The injection strategy includes the multi-stage injection count of the injector 1, the injection amount distribution, the initial injection timing, and the dwell time TP that are determined by receiving the operating condition.

The opening delay difference ΔOD may be calculated or determined from the map M of the opening delay difference ΔOD according to the fuel rail pressure, the fuel temperature, the dwell time TP, and the injection time TI.

In the step or operation S40 of driving the injector, the injector 1 is operated (i.e., driven) based on the opening delay difference ΔOD for each injection time TI of all subsequent injections following the first injection during the multi-stage injection by the injector 1.

In other words, during operation (i.e., driving) of the injector 1, the injector 1 is operated (i.e., driven) for the duration equal to each injection time TI of all subsequent injections (i.e., a plurality of subsequent injections) following the first injection during the multi-stage injection by the injector 1 minus the opening delay difference ΔOD.

For all subsequent injections (i.e., a plurality of subsequent injections) following the first injection, the injector 1 is operated (i.e., driven) by shortening the end or rear stage of each injection time TI by the opening delay difference ΔOD.

Although embodiments of the present disclosure have been described herein, it is understood that the present disclosure is not limited to the disclosed embodiments. On the contrary, the present disclosure is intended to cover various modifications and equivalent arrangements included within the spirit and scope of the appended claims.

What is claimed is:

1. An engine injector control device comprising:
an opening delay calculation unit configured to:
receive a predetermined operating condition and an injection strategy; and
determine an opening delay difference between an opening delay of a first injection and an opening delay of a subsequent injection of a plurality of subsequent injections following the first injection during a multi-stage injection by an injector; and
an injector driving unit configured to operate the injector based on the opening delay difference determined in the opening delay calculation unit.

2. The engine injector control device of claim 1, wherein the operating condition comprises at least one of an accelerator pedal operation amount, an engine speed, a fuel rail pressure, and a fuel temperature,
wherein the injection strategy is configured to be provided to the opening delay calculation unit from an injection strategy determination unit, and
wherein the injection strategy determination unit is configured to:
receive the operating condition; and
determine a multi-stage injection count, an injection amount distribution, an initial injection timing, and a dwell time.

3. The engine injector control device of claim 2, wherein an injection time calculation unit configured to receive the injection strategy and to calculate an injection time is provided between the injection strategy determination unit and the opening delay calculation unit, and
wherein the opening delay calculation unit is configured to receive the injection time from the injection time calculation unit.

4. The engine injector control device of claim 3, wherein the injector driving unit is configured to operate the injector for a duration equal to the injection time provided by the injection time calculation unit minus the opening delay difference provided by the opening delay calculation unit.

5. The engine injector control device of claim 4, wherein the injector driving unit is configured to operate the injector by shortening an end stage of the injection time by the opening delay difference.

6. The engine injector control device of claim 3, wherein the opening delay calculation unit is provided with a map of the opening delay difference according to the fuel rail pressure, the fuel temperature, the dwell time, and the injection time.

7. The engine injector control device of claim 1, wherein the injector driving unit is configured to operate the injector by subtracting the opening delay difference from each respective injection time of the plurality of subsequent injections following the first injection during the multi-stage injection.

8. The engine injector control device of claim 3, further comprising:
a closing delay calculation unit configured to:
receive the injection time from the injection time calculation unit;
calculate a closing delay;
provide the closing delay to the injector driving unit; and
correct control errors due to each respective closing delay of the first injection and the plurality of subsequent injections following the first injection during the multi-stage injection.

9. An engine injector control device comprising:
an injection time calculation unit configured to determine an injection time;
an opening delay calculation unit configured to:
receive a fuel rail pressure, a fuel temperature, a dwell time, and an injection time; and
output an opening delay difference between an opening delay of a first injection and an opening delay of a subsequent injection of a plurality of subsequent injections following the first injection during a multi-stage injection by an injector; and
an injector driving unit configured to operate the injector based on the opening delay difference provided from the opening delay calculation unit.

10. The engine injector control device of claim 9, wherein the injector driving unit is configured to operate the injector for a duration equal to each respective injection time of the plurality of subsequent injections following the first injection during the multi-stage injection minus the opening delay difference.

11. The engine injector control device of claim 10, wherein the injector driving unit is configured to operate the injector by shortening an end stage of each respective injection time by the opening delay difference.

12. The engine injector control device of claim 9, wherein the opening delay calculation unit is provided with a map of the opening delay difference according to the fuel rail pressure, the fuel temperature, the dwell time, and the injection time.

13. The engine injector control device of claim 9, further comprising:
a closing delay calculation unit configured to:
receive the injection time from the injection time calculation unit;
calculate a closing delay;
provide the closing delay to the injector driving unit; and
correct control errors due to each respective closing delay of the first injection and the plurality of subsequent injections following the first injection during the multi-stage injection.

14. An engine injector control method comprising:
determining an injection strategy of an injector by receiving a predetermined operating condition;
determining an injection time of the injector according to the injection strategy;
determining an opening delay difference between an opening delay of a first injection and an opening delay of a subsequent injection of a plurality of subsequent injections following the first injection according to the operating condition, the injection strategy, and the injection time during a multi-stage injection by the injector; and
operating the injector by using the opening delay difference.

15. The engine injector control method of claim 14, wherein the operating condition comprises at least one of an accelerator pedal operation amount, an engine speed, a fuel rail pressure, and a fuel temperature, and
wherein the injection strategy comprises a multi-stage injection count of the injector, an injection amount distribution, an initial injection timing, and a dwell time that are determined by receiving the operating condition.

16. The engine injector control method of claim 15, wherein the opening delay difference is calculated from a map of the opening delay difference according to the fuel rail pressure, the fuel temperature, the dwell time, and the injection time.

17. The engine injector control method of claim 15, wherein, in the operating of the injector, the injector is operated based on the opening delay difference for each respective injection time of the plurality of subsequent injections following the first injection during the multi-stage injection by the injector.

18. The engine injector control method of claim 15, wherein, in the operating of the injector, the injector is operated for a duration equal to each respective injection time of the plurality of subsequent injections following the first injection during the multi-stage injection by the injector minus the opening delay difference.

19. The engine injector control method of claim 18, wherein, for the plurality of subsequent injections following the first injection, the injector is operated by shortening an end stage of each respective injection time by the opening delay difference.

20. The engine injector control method of claim 12, further comprising:
determining a closing delay based on the injection time; and
correcting control errors due to each respective closing delay of the first injection and the plurality of subsequent injections following the first injection during the multi-stage injection by the injector.
